(19) United States
(12) Patent Application Publication
(10) Pub. No.: US 2007/0017493 A1
(43) Pub. Date: Jan. 25, 2007

(54) PROCESS TO DETECT THE IGNITION PHASE OF A CYLINDER IN AN INTERNAL-COMBUSTION ENGINE WITH VOLTAGE LIMITING

(75) Inventor: Laurent DUFOUR, Meximieux (FR)

Correspondence Address: DENNISON, SCHULTZ & MACDONALD, 1727 KING STREET, SUITE 105, ALEXANDRIA, VA, 22314, US

(73) Assignee: ELECTRICFIL AUTOMOTIVE, Miribel (FR)

(21) Appl. No.: 11/427,593

(22) Filed: Jun. 29, 2006

(30) Foreign Application Priority Data
Jul. 13, 2005 (FR) 05 07 5130

(51) Int. Cl. F02P 15/08; F02P 3/04

(52) U.S. Cl. 123/638; 123/650

(57) ABSTRACT

The invention concerns a process to detect the ignition phase of a cylinder in an internal combustion engine with controlled ignition, the ignition being performed by a system known as “Static twin lost spark”, formed from at least one coil (3) that includes a primary winding (4) and a secondary winding (6) wound onto a magnetic circuit (7), where the process includes the following stages:

creation of a magnetic circuit (7) not directly linked to a voltage reference (14), so that its electrical potential (V_{N1}) is an image of the mean electrical voltage of the secondary winding (6),

limiting the range of variation of the electrical potential (V_{N1}) of the magnetic circuit (7) between minimum and maximum limit values,

detecting the polarity of the electrical potential (V_{N1}) of the magnetic circuit (7) corresponding to the appearance of an ignition spark on a spark plug.

This present invention relates to the technical area of internal-combustion engines and more particularly, to engines with ignition controlled by means of spark plugs.

The invention is aiming, more precisely, at an ignition system equipping such engines and commonly known as “Static twin lost spark” or static distribution, D.L.S. (Distributor Less System) or D.I.S. (Direct Ignition System).

For a 4-cylinder engine, such an ignition system includes two coils each composed of a primary winding and a secondary winding, these coils being in a magnetic circuit. The two terminals of the secondary winding of each coil are each connected to an ignition spark plug. For each secondary winding of a coil, the associated spark plugs are those equipping the cylinders whose pistons are in synchronous positions. Thus, the cylinder associated with one of the spark plugs is in the ignition phase while the cylinder associated with the other spark plug is at the end of the exhaust phase.

Apart from this, since the polarities of the voltages supplied to each of the terminals of the secondary winding are opposed, then one of the spark plugs is fed by a positive voltage, while the other spark plug is fed by a negative voltage. The polarity of the ignition spark of a given cylinder is therefore determined by construction and wiring. It depends firstly on the construction of the ignition coil and secondly on the wiring between the terminals of the secondary winding and the spark plugs of the associated cylinders.

In such an ignition system, there is a need to know the instant at which a given cylinder is in the ignition phase, in order to allow initialisation of the fuel injection sequence into the cylinders. Such information is necessary in the case in particular of multi-point injection systems or of direct injection. Apart from this, it can be useful to know the instant at which a given cylinder is in the ignition phase, for other engine control requirements such as the detection of pinking for example.

In order to meet these requirements, we know from previous designs how to employ a suitable sensor to detect the passage of a tooth located on the camshaft of the engine and supplying a logic signal corresponding to the passage through the ignition dead point of a given cylinder. Although such a technique can be used to meet the expressed requirement, it turns out that this solution requires the use of a special sensor in combination with an appropriate processing circuit and, in certain cases, the installation on the camshafts of a special target bearing the said tooth. The cost and the difficulty of implementing such a solution are therefore high, essentially due to the need to detect the tooth at low engine speeds, the information being necessary right from start-up.

In order to overcome these drawbacks, patent FR 2 753 234, with a view to detecting the ignition phase of a cylinder in an internal combustion engine equipped with a controlled ignition device of the “Static twin lost spark” type, proposed a process consisting of:

creating a magnetic circuit which is not directly linked to a voltage reference, so that its electrical potential is an image of the mean electrical voltage of the secondary winding,

detecting the polarity of the electrical potential of the magnetic circuit corresponding to the appearance of an ignition spark on a given spark plug with a view to delivering a signal indicating that the associated cylinder is in the ignition phase.

Though such a process gives satisfaction in practice in terms of its reliability and its simplicity, it has been observed, in certain cases, that the electrical potential of the magnetic circuit was capable of reaching several hundreds of volts in pulses. It should be noted that this electrical potential depends in particular on the mechanical construction of the coil and on the choice of insulating materials.

Such a high potential can give rise to problems of safety or of disruption in the case where an operator happens to touch the magnetic circuit during a phase of operation of the coil. Apart from this, the magnetic circuit which presents a potential which is variable up to very high amplitudes, is liable to create electromagnetic radiation which is disruptive for nearby electronic equipment.

From previous designs, we also know from patent U.S. Pat. No. 5,668,311 of a device for the detection of compression in the cylinders in phase opposition of internal combustion engines with controlled ignition. Such a device includes a capacitive sensor coupled to the secondary winding of the ignition coil and linked to a compression detection circuit, equipped at its input with a stage of protection for the components of the detection circuit. It should be noted that such a detection device is associated with a magnetic circuit whose electrical potential is liable to pose problems of safety or of interference, and to create disruptive electromagnetic radiation.

The subject of the invention therefore aims to remedy the drawbacks mentioned above by proposing a process which, in full safety and without creating of disruptive electromagnetic radiation, allows detection of the ignition phase of a cylinder in an internal combustion engine equipped with a controlled ignition device of the “Static twin lost spark” type.

In order to attain such an objective, the invention concerns a process to detect the ignition phase of a cylinder in an internal combustion engine with controlled ignition, the ignition being provided by a system known as “Static twin lost spark”, formed from at least one coil which includes a primary winding and a secondary winding wound onto a magnetic circuit, with the terminals of a secondary winding being connected to first and second ignition spark plugs associated with synchronous pistons, where the process includes the following stages:

creation of a magnetic circuit not directly linked to a voltage reference, so that its electrical potential is an image of the mean electrical voltage of the secondary winding,

limiting the range of variation of the electrical potential of the magnetic circuit between predetermined minimum and maximum limit values,

detecting the polarity of the electrical potential of the magnetic circuit corresponding to the appearance of an ignition spark on a given spark plug with a view to delivering a signal indicating that the associated cylinder is in the ignition phase.

According to one characteristic of the invention, the process consists of limiting the range of variation of the electrical potential of the magnetic circuit by dissipating the power and by limiting the range of variation of the electrical potential of the magnetic circuit.

Advantageously, the process consists of detecting the negative value and the positive value of the voltage of the magnetic circuit corresponding to the appearance of an ignition spark which is respectively negative or positive on a given spark plug.

Another aim of the invention is to propose a device to detect the ignition phase of a cylinder in an internal combustion engine with controlled ignition, the ignition being performed by a system known as “Static twin lost spark”, formed from at least one coil that includes a primary winding and a secondary winding wound onto a magnetic circuit, with the terminals of a secondary winding being connected to first and second ignition spark plugs associated with synchronous pistons, the device being inserted between a voltage reference and a magnetic circuit designed to float electrically, so that the electrical potential of the magnetic circuit is an image of the mean electrical voltage of the secondary winding, where the device includes resources capable of detecting the polarity of the electrical potential of the magnetic circuit corresponding to the appearance of an ignition spark on a given spark plug, with a view to delivering a signal indicating that the cylinder associated with the said spark plug is in the ignition phase.

According to the invention, the device includes resources to limit the range of variation of the electrical potential of the magnetic circuit between predetermined minimum and maximum limit values.

Advantageously, the resources to limit the range of variation of the electrical potential include a branch for attenuation of the electrical potential mounted in parallel with a limiting branch the range of variation of the electrical potential between the predetermined minimum and maximum limit values.

For example, the branch for attenuation of the electrical potential includes attenuation impedance composed of a resistor or a capacitor, or a resistor and a capacitor mounted in parallel.

According to a preferred implementation example, the limiting branch the range of variation of the electrical potential includes a resistor mounted in series with a peak-limiting Zener diode.

According to an implementation variant, the peak-limiting Zener diode has its cathode connected to a positive voltage reference so that the minimum limit value is in the neighbourhood of V_{B}−V_{zr}, where V_{zr} is the voltage of the Zener diode on inverted connection, while the maximum limit value is in the neighbourhood of V₃+V_{zd} where V_{zd} is the transition voltage of the Zener diode on direct connection.

Preferably, the voltage reference is a positive voltage reference such as that from the positive terminal of a battery in a vehicle.

According to another implementation variant, the peak-limiting Zener diode has its anode connected to a voltage reference of zero value so that the maximum limit value is in the neighbourhood of +V_{zr}, with V_{zr} being the transition voltage of the Zener diode in the reverse connection while the minimum limit value is in the neighbourhood of −V_{zd}, with V_{zd} being the voltage of the Zener diode in direct connection.

The device advantageously includes resources to detect the negative value and the positive value of the voltage of the magnetic circuit corresponding to the appearance of an ignition spark that is respectively negative and positive on a given spark plug.

Preferably, the device includes resources for shaping of the signal, indicating that the cylinder associated with the said spark plug is in the ignition phase.

Various other characteristics will emerge from the description provided below with reference to the appended drawings which show, by way of non-limiting examples, forms of creation and implementation of the subject of the invention.

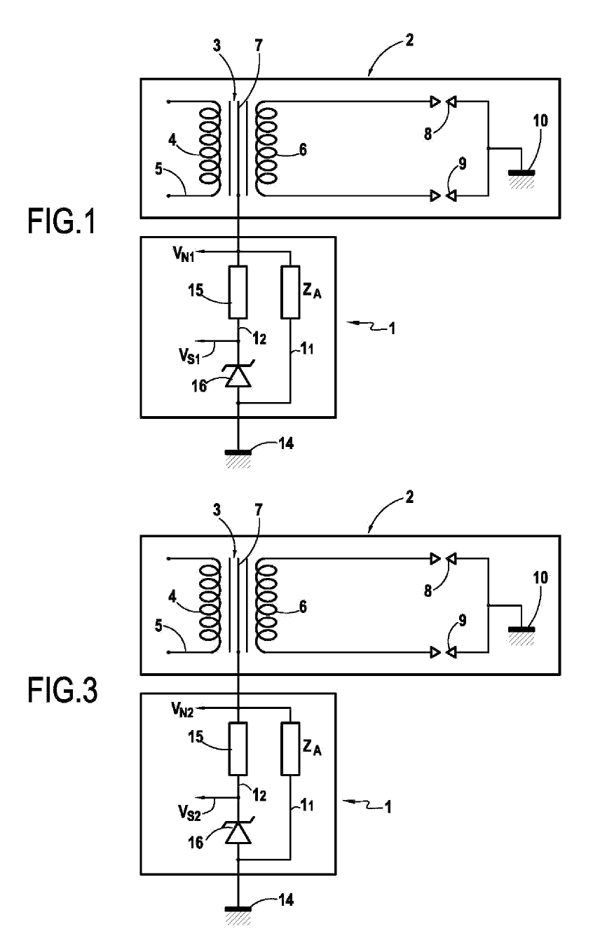

FIG. 1 is a diagram illustrating a first implementation example of a detection device of the invention.

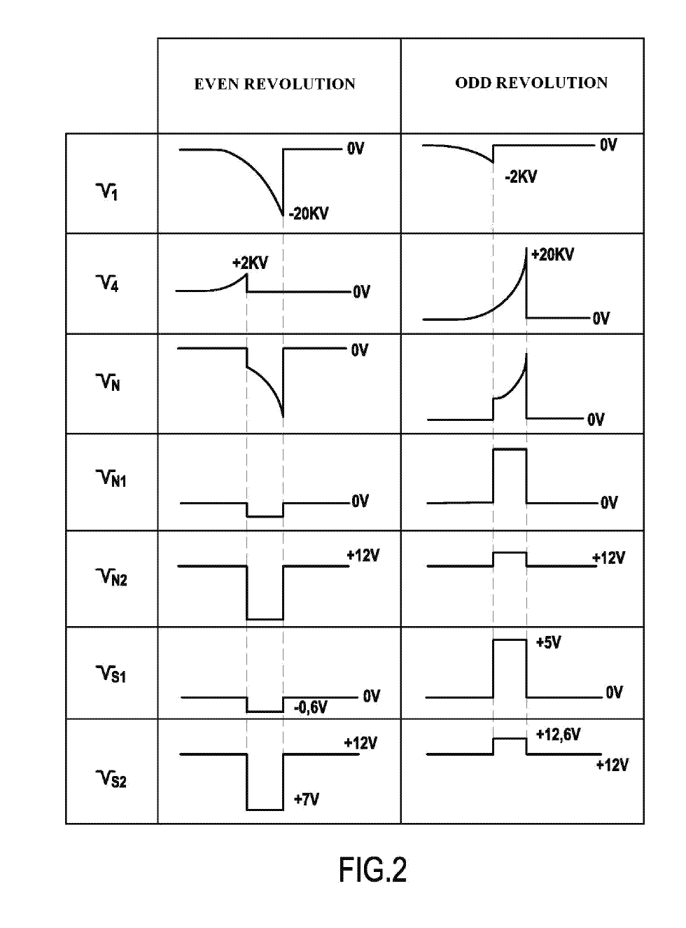

FIG. 2 is a table illustrating the principle of operation of the device of the invention.

FIG. 3 is a diagram illustrating another implementation example of a detection device according to the invention.

As illustrated by FIG. 1, the device 1 of the invention is designed to detect the ignition phase of a given cylinder of an internal combustion engine whose ignition is controlled by a system 2 known as “Static twin lost spark”. In a four-cylinder engine, an ignition system of the “Static twin lost spark” type 2 includes two ignition coils 3 only one of which is shown in the drawings. Each ignition coil 3 is composed of a primary winding 4 forming part of a primary circuit 5 which is not shown but familiar as such, and of a secondary winding 6. In a conventional manner, the primary winding 4 and the secondary winding 6 are wound onto a magnetic circuit 7. One of the terminals of the secondary winding 6 is connected to a first ignition spark plug 8, while the other terminal of the secondary winding 6 is connected to a second ignition spark plug 9. In a conventional manner, the ignition spark plugs 8, 9 which are connected to a reference potential 10, namely the electrical earth (ground), are each associated with a given cylinder of the engine. In an ignition system known as “Static twin lost spark”, the first and second spark plugs 8 and 9 correspond to those equipping the cylinders whose pistons are in synchronous positions, so that the cylinder associated with one of the spark plugs is in the ignition phase while the cylinder associated with the other spark plug is at the end of the exhaust phase. In the example illustrated, the first spark plug 8 is associated, for example, with cylinder 1 of the engine, while the second spark plug 9 is associated with cylinder 4.

It should be noted that, for a given engine revolution, the coil 3 supplies a strongly negative voltage on one of the spark plugs and a slightly positive voltage on the other spark plug, while on next engine revolution, the voltage levels are transposed on the spark plugs. Thus, as emerges more precisely from FIG. 2, on the even engine revolution for example, voltage V₁ on spark plug 8 has a high negative value in the example illustrated, of the order of −20 kilovolts for example, while voltage V₄ on spark plug 9 is slightly positive, of the order of +2 kilovolts for example. On the next engine revolution, namely the odd one, voltage V₁ on spark plug 8 is slightly negative, of the order of −2 kilovolts for example, while the voltage on spark plug 9 is high, of the order of +20 kilovolts for example. The voltages of the spark plugs associated with a given coil are therefore of opposite polarities and of high and low levels respectively. The voltages on the spark plugs are high and low for the associated cylinders, which are in the ignition phase and at the end of the exhaust phase respectively.

It must be considered that since an ignition coil 3 is composed of a primary winding 4 and a secondary winding 6 wound onto a magnetic circuit 7, there is capacitive coupling between the secondary winding 6 and the magnetic circuit 7. If the magnetic circuit 7 is electrically floating or not connected directly to a voltage reference, then the electrical potential of the magnetic circuit 7 labelled V_{N} is an image of the mean electrical voltage of the secondary winding 6. The values of potential read from the electrically floating magnetic circuit 7 are of the order of a few hundreds of Volts to a few kilovolts. To the extent that a coil 3 alternately supplies a highly positive voltage to a spark plug, and then on next engine revolution a strongly negative voltage to the other spark plug, there appears a potential V_{N} on the electrically floating magnetic circuit 7 which is alternately positive and negative. As a consequence, if on the even revolution, voltage V₁ on spark plug 8 is a negative ignition spark capable of reaching −20 kilovolts for example, while voltage V₄ on spark plug 9 is slightly positive so as to attain +2 kilovolts for example, then the mean voltage U_{MOY} of the secondary winding 6 is equal, in this example, to −9 kilovolts. The potential V_{N} of the electrically floating magnetic circuit 7, which is the image of the mean voltage U_{MOY} of the secondary winding 6, is therefore negative, reaching −3 kilovolts for example. Likewise, if on the next revolution voltage V₁ on spark plug 8 is slightly negative (−2 kilovolts for example), while voltage V₄ on spark plug 9 is a positive ignition spark capable of reaching +20 kilovolts, then the mean voltage U_{MOY} of the secondary winding 6 is therefore equal, in this example, to +9 kilovolts. The potential V_{N} of the magnetic circuit 7, which is the image of the mean voltage, is therefore positive, reaching +3 kilovolts for examples.

As emerges from the above description, the polarity of the electrical potential of the magnetic circuit 7 corresponds to the polarity of the ignition spark. As explained previously, by construction and by wiring, the polarity of the ignition spark allows us to ascertain the associated cylinder.

According to the invention, the device 1 includes resources that are capable of detecting the polarity of the electrical potential of the magnetic circuit 7, and of limiting the range of variation of the electrical potential V_{N} of the magnetic circuit 7 between predetermined minimum and maximum limit values. The detection device 1 is inserted between the electrically floating magnetic circuit 7 and a voltage reference 14. In the example illustrated in FIG. 1, the voltage reference 14 and the reference potential 10 are placed at a given value, such as the electrical earth (ground). The resources to detect the polarity of the electrical potential of the magnetic circuit 7 and to limit the range of variation of the electrical potential of the magnetic circuit, designated by V_{N1} for the example illustrated in FIG. 1, include a branch 1₁ for the attenuation of electrical potential V_{N1}, and which is used to dissipate the power. This attenuation branch 1₁ includes an impedance Z_{A} for attenuation of the electrical potential V_{N1} of the magnetic circuit 7, created for example by a resistor or a capacitor, or a resistor and a capacitor connected in parallel, between the magnetic circuit 7 and the voltage reference 14.

The resources employed to detect the polarity of the electrical potential V_{N1} and to limit the range of variation of the electrical potential V_{N1} also include a branch to limit 1₂ the range of variation of the electrical potential V_{N1} between predetermined minimum and maximum limit values. This limiting branch 1₂ is used to limit the extreme values of variation of the electrical potential V_{N1} to desired values which, for example, do not generate disruptive electromagnetic radiation or personal danger. In the implementation example illustrated, the branch 1₂ for limiting the range of variation of the electrical potential V_{N1} includes a resistor 15 mounted in series with a peak-limiting Zener diode 16. The anode of the Zener diode 16 is connected to the voltage reference 14, while its cathode, which is connected to the resistor 15, delivers a control signal V_{S1} which is meant to be used by processing or computation resources (not shown) controlling fuel injection.

The operation of the detection device 1 of the invention as illustrated in FIG. 1, flows directly from the preceding description. When the potential V_{N1} on the magnetic circuit 7 is negative in value (even revolution), then the detection device 1 delivers a negative signal V_{S1} of low value (the forward voltage of the Zener diode), corresponding to the appearance of a highly negative ignition spark on the spark plug 8 indicating that the associated cylinder is in the ignition phase. When the potential V_{N1} on the magnetic circuit 7 is positive (odd revolution), corresponding to the appearance of a positive ignition spark on the spark plug 9, then the detection resources deliver a positive voltage signal V_{S1} equal to the limiting voltage of the Zener diode 16, such as +5 Volts for example. The presence of such a positive voltage signal V_{S1}, which corresponds to the appearance of a highly positive ignition spark on the spark plug 9, indicates that the associated cylinder is in the ignition phase. The signal V_{S1} can thus be used by the computation or processing resources, in particular with a view to initialising and controlling the normal execution of the fuel injection sequence. As an example, this signal can be used on for the detection of a leading edge or the detection of a state.

According to this implementation example, it should be noted that the electrical potential V_{N1} of the magnetic circuit 7 falls between:

a minimum limit value in the neighbourhood of −V_{zd}, with V_{zd} being the transition voltage of the Zener diode in the forward direction,

a maximum limit value in the neighbourhood of +V_{zr}, with V_{zr} being the voltage of the Zener diode in the reverse connection.

The device 1 of the invention can be used to determine which of the cylinders is in the ignition phase. The detection device of the invention has the advantage of using a phenomenon that is internal to the operation of the ignition coil and unavoidable, namely the capacitive coupling between the secondary winding and the magnetic circuit. Such a device does not interfere with the operation of the coil and does not harm its performance. Safety of operation is guaranteed by the construction of the coil, by virtue of the galvanic insulation that exists between the secondary winding and the magnetic circuit. In addition, the device of the invention is of small size and low cost, and can be incorporated advantageously into the body of the coil and be embedded in resin during the impregnation of the windings. The device of the invention can be applied equally well to ignition devices composed of a coil and of a bundle of high-voltage cables or of a coil block mounted directly on the spark plugs.

In the example described above, the detection device 1 delivers a signal V_{S1} whose most characteristic level change (0 and +5 Volts in relation to 0 and −0.6 Volts) appears for a positive spark. FIG. 3 describes a preferred variant of a detection device 1 that is suitable for delivering a signal whose change of level is greatest for a negative spark. As illustrated in FIG. 3, the detection device 1 is inserted between the magnetic circuit 7 and a voltage reference 14 of positive value V_{B}, equal to the 12-Volt supply from the battery in a vehicle for example. The detection device 1 is composed, as described in FIG. 1, of an attenuation branch 1₁ that includes an impedance Z_{A}, and of a limiting branch 1₂ that includes, in the example illustrated, current-limiting resistor 15 connected in series with the anode of a peak-limiting Zener diode 16 whose cathode is connected to the voltage reference 14.

The principle of operation of this implementation variant is identical to that illustrated in FIG. 1. Thus, as emerges more precisely from FIG. 2, during the appearance of a highly negative ignition spark on spark plug 8, potential V_{N2} of magnetic circuit 7 is negative, so that there appears, between the anode of the Zener diode 16 and the reference potential 10 which is placed at the electrical earth (ground), a signal V_{S2} which is equal to the reference voltage 14 less the voltage of the Zener diode 16. Such a signal V_{S2}, equal to 7 Volts for example, can be used by a processing resource, with a view to initialising the injection sequence. During the appearance of a positive ignition spark, the detection device 1 delivers a positive voltage V_{S2} that is capable of being used, and which is equal to the reference voltage 14 plus the voltage of the Zener diode in the forward direction. This positive voltage corresponds to the appearance of a highly positive ignition spark on the spark plug 9 indicating that the associated cylinder is in the ignition phase.

It should be noted that, in this implementation example, the electrical potential V_{N2} of the magnetic circuit 7 falls between:

a minimum limit value in the neighbourhood of V_{B}−V_{zr}, with V_{zr} being the voltage of the Zener diode in the reverse connection,

a maximum limit value in the neighbourhood of V_{B}+V_{zd}, with V_{zd} the transition voltage of the Zener diode in direct connection.

In the preceding examples, the detection device 1 includes a limiting branch 1₂ with a resistor and a Zener diode. It is clear that this can be arranged to use diverse other resources to detect the polarity of the potential of the magnetic circuit 7 and to limit its range of variation. By way of an example, the detection device can use, as detection and limiting resources, resistive bridges, capacitive bridges, Zener diodes or any other appropriate system or component. Apart from this, it should be noted that the detection device 1 can include resources for shaping of the delivered signal V_{S1}, V_{S2}. These shaping resources can be composed of filters, load resistances, output stages or any other system for shaping the signal, and capable of facilitating its use by the computation resources.

Furthermore, the preceding description was for a 4-cylinder engine. It is clear that the invention can be applied equally well to an engine with two cylinders fed from a coil, or a number cylinders equal to 2×n, where n≧1.

The invention is not limited to the examples described and illustrated, since various modifications can be made to it without moving outside the scope of the following claims.

1- A process to detect the ignition phase of a cylinder in an internal combustion engine with controlled ignition, the ignition being performed by a system known as “Static twin lost spark”, formed from at least one coil (3) that includes a primary winding (4) and a secondary winding (6) wound onto a magnetic circuit (7), the terminals of a secondary winding (6) being connected to first (8) and second (9) ignition spark plugs associated with synchronous pistons, where the process includes the following stages:
creation of a magnetic circuit (7) not directly linked to a voltage reference (14), so that its electrical potential (V_{N}) is an image of the mean electrical voltage (U_{MOY}) of the secondary winding (6),
limiting the range of variation of the electrical potential (V_{N}) of the magnetic circuit (7) between predetermined minimum and maximum limit values,
detecting the polarity of the electrical potential (V_{N}) of the magnetic circuit (7) corresponding to the appearance of an ignition spark on a given spark plug with a view to delivering a signal (V_{S1}, V_{S2}) indicating that the associated cylinder is in the ignition phase.

2- A process according to claim 1, characterised in that it consists of limiting the range of variation of the electrical potential (V_{N}) of the magnetic circuit (7) by dissipating the power and by limiting the range of variation of the electrical potential (V_{N}) of the magnetic circuit (7).

3- A process according to claim 1, characterised in that it consists of detecting the negative value and the positive value of the voltage of the magnetic circuit (7) corresponding to the appearance of an ignition spark that is respectively negative or positive on a given spark plug.

4- A device to detect the ignition phase of a cylinder in an internal combustion engine with controlled ignition, the ignition being performed by a system known as “Static twin lost spark”, formed from at least one coil (3) that includes a primary winding (4) and a secondary winding (6) wound onto a magnetic circuit (7), the terminals of a secondary winding (6) being connected to first (8) and second (9) ignition spark plugs associated with synchronous pistons, the device being inserted between a voltage reference (14) and a magnetic circuit (7) designed to float electrically, so that the electrical potential (V_{N1}, V_{N2}) of the magnetic circuit (7) is an image of the mean electrical voltage (U_{MOY}) of the secondary winding (6), where the device (1) includes resources capable of detecting the polarity of the electrical potential of the magnetic circuit (7) corresponding to the appearance of an ignition spark on a given spark plug, with a view to delivering a signal (V_{S1}, V_{S2}) indicating that the cylinder associated with the said spark plug is in the ignition phase,
characterised in that it includes resources to limit the range of variation of the electrical potential (V_{N1}, V_{N2}) of the magnetic circuit (7) between predetermined minimum and maximum limit values.

5- A device according to claim 4, characterised in that the resources to limit the range of variation of the electrical potential (V_{N1}, V_{N2}) include a branch for attenuation (1₁) of the electrical potential (V_{N1}, V_{N2}), mounted in parallel with a branch (1₂) for limiting the range of variation of the electrical potential (V_{N1}, V_{N2}) between the predetermined minimum and maximum limit values.

6- A device according to claim 5, characterised in that the branch for attenuation (1₁) of the electrical potential includes an attenuation impedance (Z_{A}) composed of a resistor or a capacitor, or of a resistor and a capacitor mounted in parallel.

7- A device according to claim 5, characterised in that the branch for limiting (1₂) the range of variation of the electrical potential (V_{N1}, V_{N2}) includes a resistor mounted in series with a peak-limiting Zener diode.

8- A device according to claim 7, characterised in that the peak-limiting Zener diode has its cathode connected to a positive voltage reference (V_{B}) so that the minimum limit value is in the neighbourhood of V_{B}−V_{zr}, with V_{zr} being the voltage of the Zener diode in the reverse connection while the maximum limit value is in the neighbourhood of V_{B}+V_{zd} with V_{zd}, the transition voltage of the Zener diode in direct connection.

9- A device according to claim 8, characterised in that the voltage reference is a positive voltage reference such as that of the positive terminal of a battery in a vehicle.

10- A device according to claim 7, characterised in that the peak-limiting Zener diode (16) has its anode connected to a voltage reference of zero value so that maximum limit value is in the neighbourhood of +V_{zr} with V_{zr} being the transition voltage of the Zener diode in the reverse connection while the minimum limit value is in the neighbourhood of −V_{zd}, with V_{zd} being the voltage of the Zener diode in direct connection.

11- A device according to claim 4, characterised in that it includes resources to detect the negative value and the positive value of the voltage of the magnetic circuit (7) corresponding to the appearance of an ignition spark that is respectively negative and positive on a given spark plug.

12- A device according to claim 4, characterised in that it includes resources for shaping the signal (V_{S1}, V_{S2}) indicating that the cylinder associated with the said spark plug is in the ignition phase.
